(19) United States
(12) Patent Application Publication
(10) Pub. No.: US 2010/0162304 A1
(43) Pub. Date: Jun. 24, 2010

(54) BROADCAST PROCESSING APPARATUS AND CONTROL METHOD THEREOF

(75) Inventors: Chang-seog KO, Hwaseong-si (KR); Won-il KIM, Gwacheon-si (KR); Yong-hwan KWON, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/545,210

(22) Filed: Aug. 21, 2009

(30) Foreign Application Priority Data
Dec. 19, 2008 (KR) 10-2008-0129819

(51) Int. Cl. G06F 3/00

(52) U.S. Cl. 725/37

(57) ABSTRACT

Disclosed is a broadcast processing apparatus including: an image processor which processes an image received through at least one transmission method and at least one processing method; a display unit which displays thereon the image processed by the image processor; a user interface (UI) provider which provides a setup UI to select a transmission method and a processing method, through which an automatic channel setup is performed, among the at least one transmission method and the at least one processing method, respectively; and a controller which displays the setup UI on the display unit if the automatic channel setup is initiated, and performs the automatic channel setup through the transmission method and the processing method selected through the setup UI.

### CROSS-REFERENCE TO RELATED APPLICATION

This application claims priority from Korean Patent Application No. 10-2008-0129819, filed on Dec. 19, 2008, in the Korean Intellectual Property Office, the disclosure of which is incorporated herein by reference.

### BACKGROUND OF THE INVENTION

1. Field of the Invention

Apparatuses and methods consistent with the present invention relate to a broadcast processing apparatus and a control method thereof, and more particularly, to a broadcast processing apparatus and a control method thereof which displays a setup user interface (UI) to select a transmission method and a processing method for performing an automatic channel setup, performs an automatic channel setup through the transmission method and the processing method selected by a user through the setup UI, enables a user to perform an automatic channel setup through a desired method according to the user's preference and perform the automatic channel setup more easily.

2. Description of the Related Art

A broadcast processing apparatus, e.g., a digital television (DTV) processes a received broadcasting signal and displays the broadcasting signal on a display panel such as a liquid crystal display (LCD). In recent years, the DTV has been consolidated into a broadcasting system which receives and displays cable broadcasting, satellite broadcasting, Internet protocol television (IPTV) broadcasting as well as existing terrestrial broadcasting. Meanwhile, a user should search available channels through an automatic channel setup and store the searched channels to view a broadcasting through the DTV.

Hereinafter, a related art automatic channel setup will be described in detail. A user selects one of broadcasting transmission methods such as terrestrial broadcasting, cable broadcasting, satellite broadcasting and IPTV broadcasting. Next, the user selects one of broadcasting processing methods such as an analog processing method and a digital processing method corresponding to the previously selected transmission method and performs an automatic channel setup. The user performs an automatic channel setup through another broadcasting transmission method and another broadcasting processing method. For example, a user selects “cable” as a transmission method and then “digital” as a processing method corresponding to the cable transmission method. After performing the automatic channel setup, a user selects “terrestrial” as a transmission method and “analog” as a processing method to perform another automatic channel setup.

As described above, the related art automatic channel setup is performed through each of the broadcasting transmission methods and the broadcasting processing methods. Accordingly, the automatic channel setup is complex, and channels are searched through each broadcasting transmission method. As a result, a user may be confused as if several rounds of automatic channel setup are performed.

### SUMMARY OF THE INVENTION

The foregoing and/or other aspects of the present invention may be achieved by providing a broadcast processing apparatus including: an image processor which processes an image received through at least one transmission method and at least one processing method; a display unit which displays thereon the image processed by the image processor; a UI provider which provides a setup UI to select a transmission method and a processing method, through which an automatic channel setup is performed, among the at least one transmission method and the at least one processing method; and a controller which displays the setup UI on the display unit if the automatic channel setup is selected, and performs the automatic channel setup through the transmission method and the processing method selected through the setup UI.

The at least one transmission method may include at least one of a terrestrial transmission method, a cable transmission method, a satellite transmission method, an IPTV transmission method and an external device transmission method.

The at least one processing method may include at least one of an analog processing method and a digital processing method.

The setup UI may be provided as a table which has the at least one transmission method arranged on one side and the at least one processing method arranged in another side.

The setup UI may be provided to select or cancel a cell located at an intersection of the one side and the other side and select the transmission method and the processing method, through which the automatic channel setup is performed.

The setup UI may display the at least one transmission method on one side and may display on the other side, as a box shape, the at least one processing method corresponding to the selected transmission method if one of the at least one transmission method is selected.

The setup UI may be provided to select or cancel the at least one processing method displayed in the box to select the transmission method and the processing method, through which the automatic channel setup is performed.

The at least one processing method may include at least one of a phase alternation by line (PAL) method, a national television system committee (NTSC) method and a sequential color and memory (SECAM) method.

Another aspect of the present invention can be achieved by providing a control method of a broadcast processing apparatus, the control method including: displaying a setup UI to select a transmission method and a processing method, through which an automatic channel setup is performed, among the at least one transmission method and the at least one processing method if the automatic channel setup is selected; and performing the automatic channel setup through the transmission method and the processing method selected through the setup UI.

The at least one transmission method may include at least one of a terrestrial transmission method, a cable transmission method, a satellite transmission method, an IPTV transmission method and an external device transmission method.

The at least one processing method may include at least one of an analog processing method and a digital processing method.

The setup UI may be provided as a table which has the at least one transmission method arranged on one side and the at least one processing method arranged on another side.

The setup UI may be provided to select or cancel a cell located at an intersection of the one side and the other side and select the transmission method and the processing method, through which the automatic channel setup is performed.

The setup UI may display the at least one transmission method on one side and may display on the other side, as a box shape, the at least one processing method corresponding to the selected transmission method if one of the at least one transmission method is selected.

The setup UI may be provided to select or cancel the at least one processing method displayed in the box to select the transmission method and the processing method, through which the automatic channel setup is performed.

The at least one processing method may include at least one of a PAL method, an NTSC method and a SECAM method.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is a block diagram of a broadcast processing apparatus according to an exemplary embodiment of the present invention;

FIG. 2 illustrates an example of a setup UI according to an exemplary embodiment of the present invention;

FIG. 3 illustrates an example of a setup UI according to an exemplary embodiment of the present invention;

FIG. 4 illustrates an example of a setup UI according to an exemplary embodiment of the present invention; and

FIG. 5 is a flowchart of an automatic channel setup of the broadcast processing apparatus according to an exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

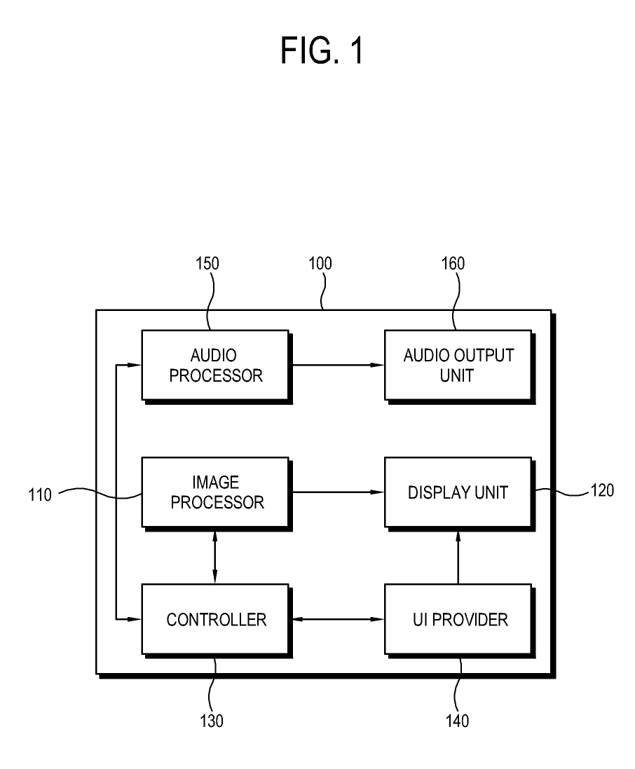

FIG. 1 is a block diagram of a broadcast processing apparatus according to an exemplary embodiment of the present invention.

As shown therein, a broadcast processing apparatus 100 according to the exemplary embodiment of the present invention processes a received broadcasting signal and displays the broadcasting signal on a display panel such as a LCD. The broadcast processing apparatus 100 may include, e.g., a digital TV.

According to the exemplary embodiment of the present invention, if a user initiates or triggers an automatic channel setup, the broadcast processing apparatus 100 displays on the display unit 120 a setup UI for a user to select a transmission method and a processing method through which the automatic channel setup is performed, and performs the automatic channel setup according to the transmission method and processing method selected through the setup UI. The selection of the transmission method refers to a selection of a broadcasting transmission method such as terrestrial broadcasting, cable broadcasting, satellite broadcasting, IPTV broadcasting, external device, etc. The selection of the processing method refers to a selection of a broadcasting processing method such as an analog processing method and a digital processing method.

As shown therein, the broadcast processing apparatus 100 according to the exemplary embodiment of the present invention includes an image processor 110 which processes a received image, a display unit 120 which displays thereon an image processed by the image processor 110, a UI provider 140 which provides a setup UI to select a transmission method and a processing method, through which an automatic channel setup is performed, and a controller 130 which displays the setup UI on the display unit 120 if the automatic channel setup is initiated or triggered by the user, and performs the automatic channel setup according to the transmission method and the processing method selected through the setup UI.

The broadcast processing apparatus 100 according to the exemplary embodiment of the present invention further includes an audio processor 150 which processes an audio of the broadcasting signal and an audio output unit 160 which outputs the audio processed by the audio processor 150.

Hereinafter, each element will be described.

The image processor 110 decodes image data included in the broadcasting signal to a decoding format corresponding to an encoding format according to which the broadcasting signal is transmitted, and converts a vertical frequency, a resolution and a picture ratio of the image data to meet output standards of the display unit 120. The image processor 110 may include an image processing module such as a scaler. According to an exemplary embodiment of the present invention, the image processor 110 processes an image received through at least one transmission method such as terrestrial broadcasting, cable broadcasting, satellite broadcasting, IPTV broadcasting, external device, etc. and at least one processing method such as an analog processing method and a digital processing method to be displayed on the display unit 120.

The display unit 120 displays thereon an image processed by the image processor 110. The display unit 120 may include a display panel (not shown) to display an image thereon, and a panel driver (not shown) to drive the display panel. The display unit 120 according to an exemplary embodiment of the present invention may include various types of display modules such as a digital light processing (DLP), an LCD and a plasma display panel (PDP).

The audio processor 150 processes audio data included in the broadcasting signal to decode it to a decoding format corresponding to an encoding format by which the broadcasting signal is transmitted. Then, the audio processor 150 outputs the audio data to the audio output unit 160.

The audio output unit 160 outputs the audio processed by the audio processor 150. The audio output unit 160 may include a plurality of speakers (not shown) with a plurality of channels.

According to an exemplary embodiment of the present invention, if an automatic channel setup is initiated or triggered by a user, the UI provider 140, in accordance with a control of the controller 130 (to be described later), displays a setup UI on the display unit 120 so that a user may select a desired transmission method and a processing method, through which the automatic channel setup is performed. As described above, the transmission method may include terrestrial broadcasting, cable broadcasting, satellite broadcasting, IPTV broadcasting, external device, etc. while the processing method may include an analog processing method or a digital processing method.

Hereinafter, the setup UI which is provided by the UI provider 140 to perform the automatic channel setup will be described in more detail. According to an exemplary embodiment of the present invention, the setup UI provides a table in which at least one transmission method is arranged in a lateral axis and at least one processing method is arranged in another lateral axis. A user may select or cancel a cell located at an intersection of the axis of the transmission method and the axis of the processing method to thereby select a desired transmission method and a desired processing method, through which the automatic channel setup is performed.

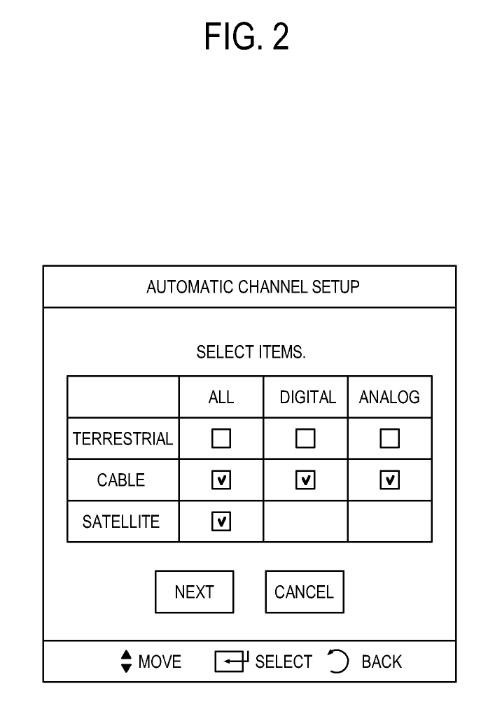

For example, FIG. 2 illustrates an example of the setup UI according to an exemplary embodiment of the present invention. As shown therein, the setup UI provides a table with 3×3 cells in which a transmission method such as “TERRESTRIAL”, “CABLE”, and “SATELLITE” are arranged in a vertical axis and a processing method such as “ALL”, “DIGITAL” and “ANALOG” are arranged in a horizontal axis. Here, the item “ALL” is provided to select both the digital processing method and the analog processing method at a time.

A user selects or cancels a check box provided in each cell of the table to select a transmission method and a processing method, through which the automatic channel setup is performed. For example, if a user desires to perform an automatic channel setup through a cable transmission method and a digital processing method, the user may select the check box provided in a cell positioned in an intersection of the row of the cable transmission method and the column of the digital processing method. If a user desires to perform an automatic channel setup through a terrestrial transmission method and digital/analog processing methods, the user may select the check box provided in a cell positioned in an intersection of the row of the cable transmission method and the column of the digital processing method.

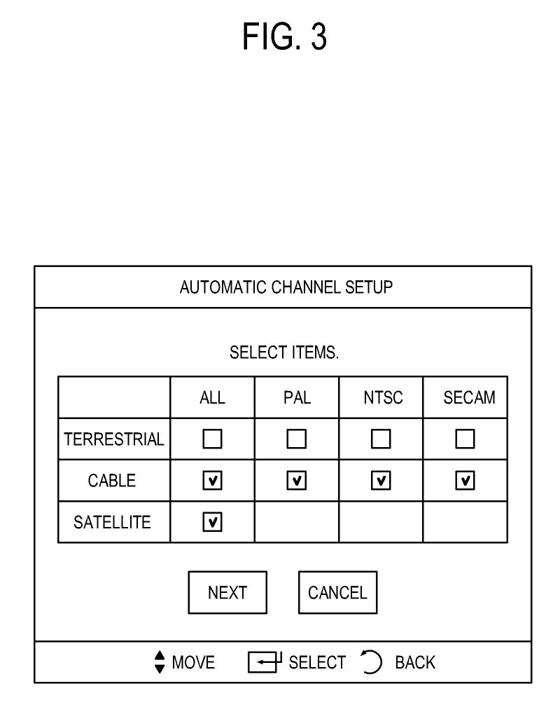

According to an exemplary embodiment of the present invention, a setup UI may include a phase alternation by line (PAL) processing method, a national television system committee (NTSC) processing method and a sequential color and memory (SECAM) processing method. FIG. 3 illustrates an example of a setup UI which shows items such as PAL, NTSC and SECAM in a horizontal axis of the table of the previous exemplary embodiment. Thus, the setup UI is provided as a table with 3×4 cells.

According to the present exemplary embodiment, a user may select different broadcasting processing methods depending on countries. The process of selecting a transmission method and a processing method, through which an automatic channel setup is performed, is the same as that according to the previous exemplary embodiment. Thus, detailed descriptions will be omitted.

According to an exemplary embodiment of the present invention, a setup UI includes at least one transmission method. Thus, if one of the at least one transmission method is selected, at least one processing method corresponding to the selected transmission method is displayed as a box in another axis. A user may select or cancel one of the at least one processing method displayed in a box to thereby select the transmission method and the processing method, through which the automatic channel setup is performed.

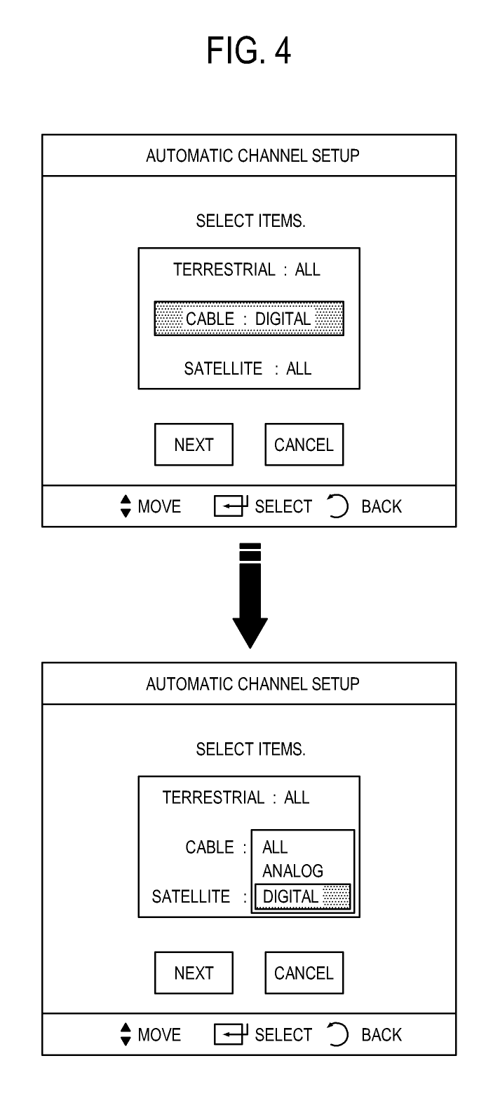

FIG. 4 illustrates an example of a setup UI according to an exemplary embodiment of the present invention. As shown therein, a setup UI displays transmission methods such as terrestrial broadcasting, cable broadcasting and satellite broadcasting on a left side. If a user selects one of the transmission methods, the setup UI displays processing methods such as “ALL”, “DIGITAL” and “ANALOG” in a box on a right side. Here, the item “ALL” is provided to select both the digital processing method and the analog processing method at a time.

A user selects or cancels one of the processing methods displayed in the box to thereby select the transmission method and the processing method, through which the automatic channel setup is performed. For example, if a user desires to perform an automatic channel setup through a cable transmission method and a digital processing method, the user selects “CABLE” displayed on the left side and then “DIGITAL” from a box displayed on the right side according to the selected cable item. If a user desires to perform an automatic channel setup through a “TERRESTRIAL” transmission method and both of a digital processing method and an analog processing method, the user selects “TERRESTRIAL” displayed on the left side and then “ALL” from the box displayed on the right side according to the selected item “TERRESTRIAL” broadcasting.

For purposes of convenience, in the foregoing exemplary embodiments, tables or boxes in which items such as “TERRESTRIAL”, “CABLE” and “SATELLITE” transmission methods and “ALL”, “DIGITAL” and “ANALOG” processing methods are displayed are provided, but the spirit of the present invention is not limited to the foregoing.

The controller 130 controls overall operations of the elements. According to an exemplary embodiment of the present invention, if a user initiates or triggers an automatic channel setup, the controller 130 controls the UI provider 140 to display a setup UI on the display unit 120, and perform the automatic channel setup through a transmission method and a processing method selected by a user through the setup UI. As described above, the controller 130 performs the automatic channel setup through the transmission method and the processing method selected through the setup UI.

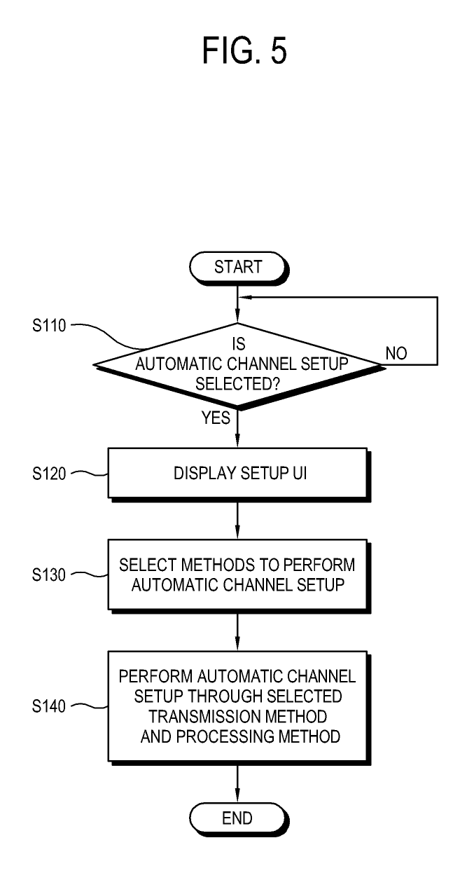

With the foregoing configuration, a process of performing the automatic channel setup in the broadcast processing apparatus 100 according to an exemplary embodiment of the present invention will be described with reference to FIG. 5.

As shown therein, the controller 130 determines whether a user initiates or triggers an automatic channel setup through a key (not shown) provided in the image processing apparatus 100 of FIG. 1 or a remote controller (not shown) (S110).

If the user selects the automatic channel setup, the controller 130 controls the UI provider 140 and the display unit 120 to display on the display unit 120 a setup UI (S120) so that the user may select a transmission method and a processing method to perform the automatic channel setup is performed (S130).

If the user selects a transmission method and a processing method, the controller 130 performs the automatic channel setup through the transmission method and the processing method selected by the user through the setup UI (S140).

The setup UI is the same as those according to the previous exemplary embodiments of the present invention. Thus, detailed description will be avoided.

If the user selects the automatic channel setup, the broadcast processing apparatus 100 displays the setup UI for a user to select the transmission method and the processing method, through which the automatic channel setup is performed, and performs the automatic channel setup through the transmission method and the processing method selected by a user through the setup UI. Thus, the user not only performs the automatic channel setup through a desired method according to the user's preference, but also performs the automatic channel setup more conveniently.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcast processing apparatus comprising:
an image processor which processes an image received through at least one transmission method and at least one processing method;
a display unit which displays thereon the image processed by the image processor;
a user interface (UI) provider which provides a setup UI to select a transmission method for transmitting data of the image to the broadcasting processing apparatus and a processing method for processing the data of the image in the broadcasting processing apparatus, through which an automatic channel setup is performed, among the at least one transmission method and the at least one processing method, respectively; and
a controller which displays the setup UI on the display unit if the automatic channel setup is initiated, and performs the automatic channel setup through the transmission method and the processing method selected through the setup UI.

2. The broadcast processing apparatus according to claim 1, wherein the at least one transmission method comprises at least one of a terrestrial transmission method, a cable transmission method, a satellite transmission method, an Internet protocol television transmission method and an external device transmission method.

3. The broadcast processing apparatus according to claim 2, wherein the at least one processing method comprises at least one of an analog processing method and a digital processing method.

4. The broadcast processing apparatus according to claim 3, wherein the setup UI is provided as a table which has the at least one transmission method arranged on one side and the at least one processing method arranged in another side.

5. The broadcast processing apparatus according to claim 4, wherein the setup UI is provided to select or cancel a cell located at an intersection of the one side and the other side and select the transmission method and the processing method, through which the automatic channel setup is performed.

6. The broadcast processing apparatus according to claim 3, wherein the setup UI displays the at least one transmission method on one side and displays on another side, as a box shape, the at least one processing method corresponding to the selected transmission method if one of the at least one transmission method is selected.

7. The broadcast processing apparatus according to claim 6, wherein the setup UI is provided to select or cancel the at least one processing method displayed in the box to select the transmission method and the processing method, through which the automatic channel setup is performed.

8. The broadcast processing apparatus according to claim 3, wherein the at least one processing method comprises at least one of a phase alternation by line (PAL) method, a national television system committee (NTSC) method and a sequential color and memory (SECAM) method.

9. The broadcast processing apparatus according to claim 1, wherein the at least one transmission method comprises at least one of a terrestrial transmission method, a cable transmission method, a satellite transmission method, an Internet protocol television transmission method and an external device transmission method,
wherein the at least one processing method comprises at least one of an analog processing method and a digital processing method.

10. A control method of a broadcast processing apparatus, the control method comprising:
displaying a setup user interface (UI) to select a transmission method for transmitting data of the image to the broadcasting processing apparatus and a processing method for processing the data of the image in the broadcasting processing apparatus, through which an automatic channel setup is performed, among at least one transmission method and at least one processing method, respectively, if the automatic channel setup is initiated; and
performing the automatic channel setup through the transmission method and the processing method selected through the setup UI.

11. The control method according to claim 10, wherein the at least one transmission method comprises at least one of a terrestrial transmission method, a cable transmission method, a satellite transmission method, an Internet protocol television transmission method and an external device transmission method.

12. The control method according to claim 11, wherein the at least one processing method comprises at least one of an analog processing method and a digital processing method.

13. The control method according to claim 12, wherein the setup UI is provided as a table which has the at least one transmission method arranged on one side and the at least one processing method arranged on another side.

14. The control method according to claim 13, wherein the setup UI is provided to select or cancel a cell located at an intersection of the one side and the other side and select the transmission method and the processing method, through which the automatic channel setup is performed.

15. The control method according to claim 12, wherein the setup UI displays the at least one transmission method on one side and displays on another side, as a box shape, the at least one processing method corresponding to the selected transmission method if one of the at least one transmission method is selected.

16. The control method according to claim 15, wherein the setup UI is provided to select or cancel the at least one processing method displayed in the box to select the transmission method and the processing method, through which the automatic channel setup is performed.

17. The control method according to claim 12, wherein the at least one processing method comprises at least one of a phase alternation by line (PAL) method, a national television system committee (NTSC) method and a sequential color and memory (SECAM) method.

18. The control method according to claim 10, wherein the at least one transmission method comprises at least one of a terrestrial transmission method, a cable transmission method, a satellite transmission method, an Internet protocol television transmission method and an external device transmission method,
wherein the at least one processing method comprises at least one of an analog processing method and a digital processing method.

19. A broadcast processing apparatus comprising:
an image processor which processes an image received through at least one transmission method and at least one processing method;
a display unit which displays thereon the image processed by the image processor;
a user interface (UI) provider which provides a setup UI in which a user is allowed to select a combination of a transmission method for transmitting data of the image to the broadcasting processing apparatus, among the at least one transmission method, and a processing method for processing the data of the image in the broadcasting processing apparatus, among the at least one processing method, to perform an automatic channel setup; and
a controller which displays the setup UI on the display unit if the automatic channel setup is triggered by a user, and performs the automatic channel setup through the combination of the transmission method and the processing method selected through the setup UI,
wherein by selecting the combination, the transmission method and the processing method are selected at a time.

20. The broadcast processing apparatus of claim 19, wherein the at least one transmission method comprises at least one of a terrestrial transmission method, a cable transmission method, a satellite transmission method, an Internet protocol television transmission method and an external device transmission method,
wherein the at least one processing method comprises at least one of an analog processing method and a digital processing method.
